(19) United States
(12) Patent Application Publication
(10) Pub. No.: US 2021/0278751 A1
(43) Pub. Date: Sep. 9, 2021

(54) ROLLING STAND BASE

(71) Applicant: Bo Christensen, Nordborg (DK)

(72) Inventor: Bo Christensen, Nordborg (DK)

(73) Assignee: SAVAGE UNIVERSAL CORP, CHANDLER, AZ (US)

(21) Appl. No.: 16/873,242

(22) Filed: Mar. 3, 2020

(51) Int. Cl. G03B 17/56; F16M 11/42

(52) U.S. Cl. CPC G03B 17/561; G03B 15/06; F16M 11/42

(57) ABSTRACT

A rolling base having two leg members connected to a hinge mechanism. Three wheels support the rolling base, each leg having one wheel each with the third wheel secured to the hinge mechanism. Two attachments are provided, one at the hinge with a second positioned between the legs. The attachment mechanisms accepting support members used to support lights, cameras, and other accessories.

### PRIORITY

Priority for this application is taken from U.S. provisional patent application Ser. No. 62/919,678, filed Mar. 22, 2019, and entitled “Rolling C-Stand Base”.

### BACKGROUND OF THE INVENTION

While the discussion herein relates to photography equipment, the invention is not intended to be limited to this field but has applications in other fields and uses as those of ordinary skill art readily recognize.

There are a variety of stands well known to those of ordinary skill in the art, including, but limited to: U.S. Pat. No. 10,492,377, issued Dec. 3, 2019, to Volin and entitled “Unique Rollable Five-Device-in-One System Comprising Rollable Clawed-Foot Flower Container, Rollable Adjustable-Receiver Umbrella Stand, Rollable Water-Reservoir, Rollable Water-Regulating Irrigation System and Rollable Water Circulating System”; U.S. Pat. No. 10,259,026, issued Apr. 16, 2019, to Dorigo et al. and entitle “Rolling Stand and Corresponding Method”; U.S. Pat. No. 10,300,514, issued May 28, 2019, to Pozzo and entitled Rolling Station and Rolling Mill Plant”; and, U.S. Pat. No. 10,016,797, issued Jul. 10, 2018, to Vasi et al. and entitled “Rolling Unit”; and of which are incorporated hereinto by reference.

Within the photography field there is a significant need for bases to hold not only cameras, but lights, screens, shades, and a host of other accessories. Often these stands are standalone items which are used to hold a single item but can also be used in tandem to secure an item such as a light using two of the standalone stands with a boom.

As such, movement of the assembly requires that the assembly must be dismantled, individual components transported, and then reassembled. Clearly, this takes a significant amount of time.

When the base is supported on wheels, the base is often difficult to collapse and move.

Without the ability to collapse or shrink the base, storage and transportation becomes very difficult.

Legs on the stands, while providing some stability, often make it difficult or unstable when the legs are fully extended.

Even in the best of situations, stability of the existing art is tenuous; and storage remains a major problem.

It is clear there is a continuing need for a versatile and stable base.

### SUMMARY OF THE INVENTION

The invention is a rolling base having two leg members connected to a hinge mechanism. Ideally, three wheels support the rolling base, each leg having one wheel with the third wheel secured to the hinge mechanism. In the preferred embodiment, two attachment receptacles are provided for acceptance of mounting mechanisms for lights, cameras, and accessories. The attachment receptacles are spaced apart, one at the hinge with a second positioned substantially at a center line of the legs.

Those ordinary skill in the art readily recognize a variety of attachment receptacles. For this discussion, tubes accepting poles are used.

In this manner, the base of this invention utilizes a first leg and a second leg, the first leg and the second leg are secured to each other via a hinge mechanism. Wheels in the preferred embodiment are secured to: the distal end of the first leg; the distal end of the second leg, and the hinge. A first attachment receptacle is secured proximate to the hinge mechanism, with a second attachment receptacle positioned between the legs using an arm mechanism.

Ideally, the legs are selectively elongated for additional stability; and collapsible for storage.

In the ideal base, a limiting mechanism is provided to keep the legs from being widened beyond a selected range. In the preferred embodiment, this limit is fifty-six degrees to assure stability.

In the preferred embodiment, supports are provided to engage with the attachment receptacles. These supports have an attachment mechanism located at their distal ends to accept items such as lights, cameras, booms and the such. These supports are adjustable in length to comply with the requirements of the situation.

Further, an arm serving as a boom is also connectable to the supports allowing an end of the arm to extend past the leg ends to hold a light, microphone, or camera over a subject.

With the addition of grips (located at the distal ends on the upper side) the legs then provide for a base for a screen or such while the support provides for the backing of the screen.

The invention, together with various embodiments thereof, will be more fully explained by the accompanying drawings and following description thereof.

### DRAWINGS IN BRIEF

FIG. 1 is a perspective view of the preferred embodiment of the invention.

FIG. 2 illustrates the extension of the legs.

FIG. 3 illustrates the preferred embodiment in a collapsed state.

FIG. 4 illustrates the use of the stand to position an overhead light.

FIG. 5 illustrates the use of the stand to support a screen.

### DRAWINGS IN DETAIL

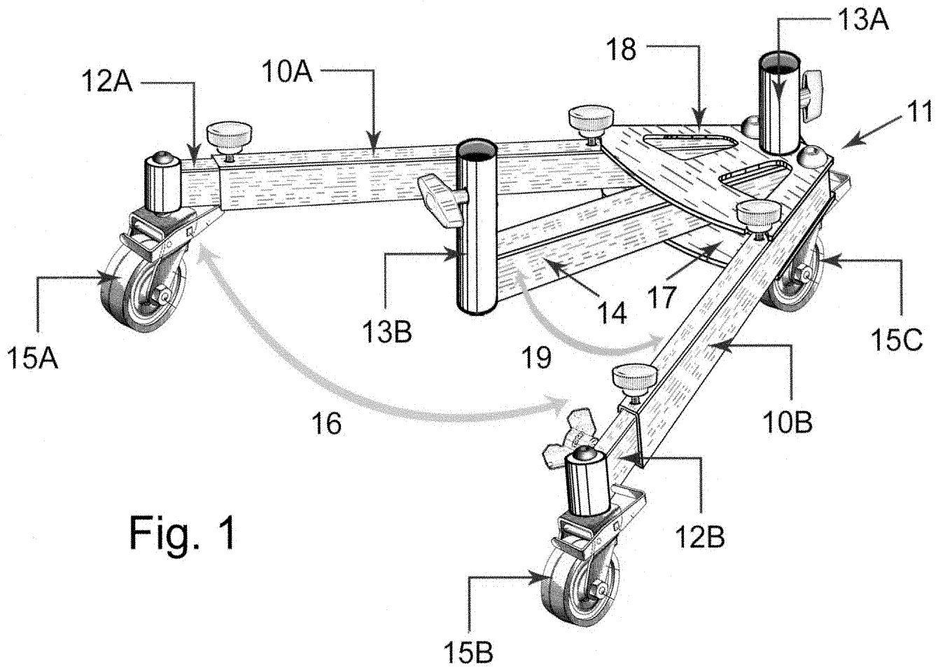

FIG. 1 is a perspective view of the preferred embodiment of the invention.

The invention creates a double receiver rolling base for a c-stand column. With extendable legs, additional stability is obtained; yet the stand/base folds up compactly and is still rollable.

The fundamental parts of this embodiment include legs 10A and 10B which are secured to each other via hinge 11. Each leg 10A and 10B is extendable using telescoping pieces 12A and 12B.

The assembly is supported by wheels 15A, 15B, and 15C. The base is collapsible as illustrated by arrow 16.

Two receivers, 13A and 13B, are provided which accept stands/poles thereinto. Receiver 13B is positioned between the legs 10A and 10B and is positioned by arm 14 (which, in an alternative embodiment is extendable). As shown, arm 14 is supported by a portion 17 of hinge 11. In this embodiment, arm 14 is positioned between portion 17 of the hinge 11 as the upper range limiting member 18. Range limiting member 18 is also used, in some embodiments, to allow arm 14 to swivel, as shown by arrow 19) to obtain even more versatility.

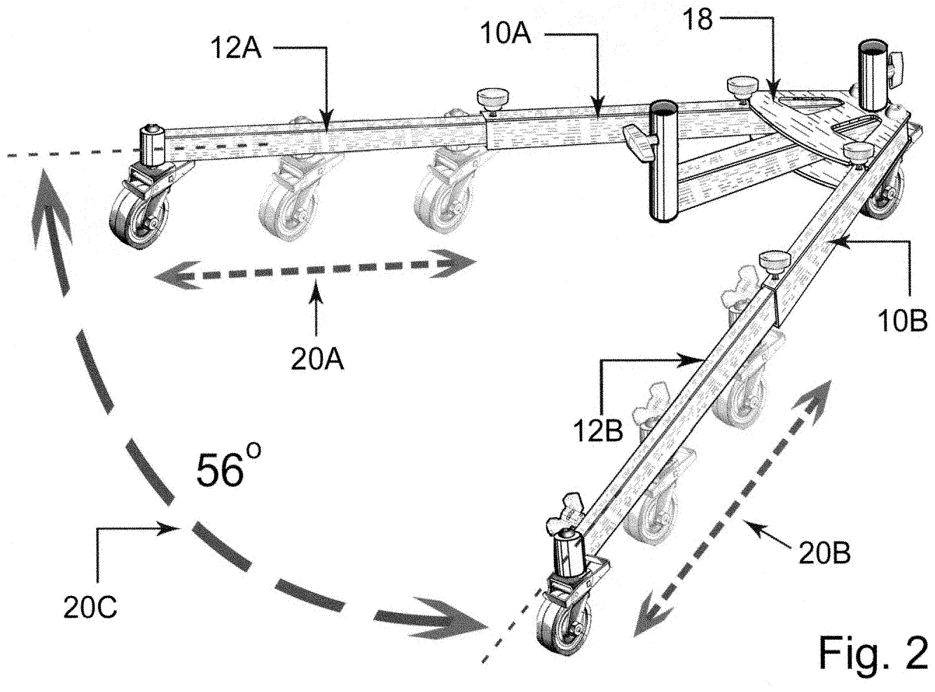

FIG. 2 illustrates the extension of the legs.

Leg 10A has, in this illustration, extension 12A elongated as shown by arrow 20A; in like manner, leg 10B has extension 12B elongated as shown by arrow 20A. Limiting mechanism 18, regardless of the overall length of the legs, keeps the angle at a desired 56 degrees to maintain stability.

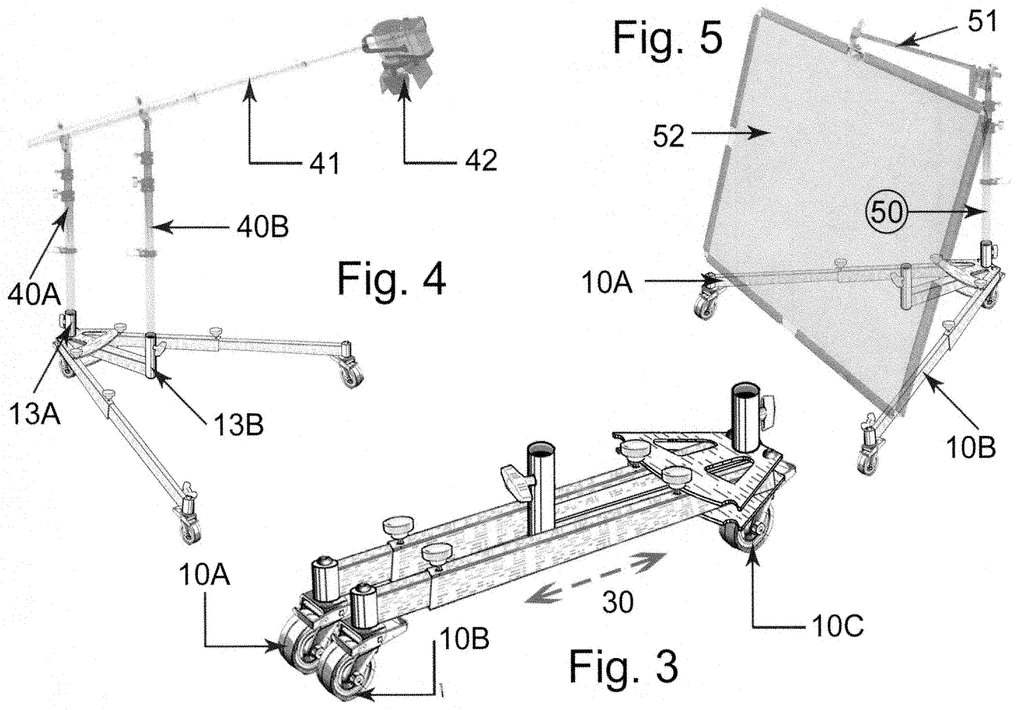

FIG. 3 illustrates the preferred embodiment in a collapsed state.

Note, as illustrated, the collapsed stand maintains its wheels 10A, 10B, and 10C positioned to allow the collapsed stand to be easily rolled for storage as illustrated by arrow 30.

FIG. 4 illustrates the use of the stand to position an overhead light.

The rolling base has been described before. Two columns 40A and 40B are used in this embodiment. Column 40A is secured to receiver 13A while column 40B is secured to receiver 13B. Each column 40A and 40B are extendable to different lengths.

Secured to the top of column 40A and to column 40B is boom 41 which holds light 42. In this manner, the entire assembly is movable or repositioned without having to dismantle the assembly.

While this illustration shows light 42, other accessories such as cameras or microphones may also be used in this context.

While this illustration shows the use of two columns, a single column is also contemplated to hold a variety of implements useful in the various industries.

FIG. 5 illustrates the use of the stand to support a screen 51.

Screen 51 is supported by legs 10A and 10B. The top of screen 51 is positioned by column 50 and boom 51. Once so assembled, the assemblage is easily moved to address another situation.

It is clear that the present invention provides for a highly versatile base which is adapted to hold a variety of implements.

What is claimed is:

1. A base comprising:
a) A first leg and a second leg, said first leg and the second leg secured to each other at their second ends via a hinge mechanism;
b) A first wheel secured to the first end of the first leg;
c) A second wheel secured to the first end of the second leg;
d) A third wheel secured to the hinge mechanism;
e) A first attachment receptacle secured proximate to the hinge mechanism;
f) An arm mechanism extending from the hinge mechanism between the first leg and the second leg; and,
g) A second attachment receptacle positioned at an end of the arm mechanism.

2. The base according to claim 1, wherein the first leg and the second leg are selectively elongated.

3. The base according to claim 2, further including a limiting mechanism positioned proximate to the hinge mechanism, said limiting mechanism establishing a maximum angle between the first leg and the second leg.

4. The base according to claim 3, wherein the maximum angle is fifty six degrees.

5. The base according to claim 2, further including a first support, a proximal end thereof configured to be accepted by either the first attachment mechanism or the second attachment mechanism.

6. The base according to claim 5, wherein the first support is adjustable in length and wherein a distal end of the first support mechanism is configured to be secured to an accessory.

7. The base according to claim 6, further including a second support, a proximal end thereof configured to be accepted by either the first attachment mechanism or the second attachment mechanism.

8. The base according to claim 7, further including a beam adapted to be secured a distal end of the first support and a distal end of the second support such that an end of the boom extends past the second end of the first leg and the second end of the second leg.

9. The base according to claim 5, wherein the first leg includes a first bracket secured proximal to the second end of the first leg.

10. The base according to claim 9, wherein the second leg includes a second bracket secured proximal to the second end of the first leg.

11. A base comprising:
a) A first leg and a second leg, said first leg and the second leg secured to each other at their second ends via a hinge mechanism, said first leg, second leg, and hinge mechanism on rollers;
b) A first attachment receptacle secured proximate to the hinge mechanism;
c) An arm mechanism extending from the hinge mechanism between the first leg and the second leg; and,
d) A second attachment mechanism positioned at an end of the arm mechanism.

12. The base according to claim 11, further including a first support, a proximal end thereof configured to be accepted by either the first attachment mechanism or the second attachment mechanism, said first support being adjustable in length, a distal end of the first support configured to be secured to an accessory.

13. The base according to claim 12, further including a second support, a proximal end thereof configured to be accepted by either the first attachment mechanism or the second attachment mechanism, said second support being adjustable in length, a distal end of the second support configured to be secured to an accessory.

14. A base comprising:
a) A first leg and a second leg, said first leg and the second leg secured to each other at their second ends via a hinge mechanism allowing the first leg and second leg to collapse next to each other;
b) A first wheel secured to the first end of the first leg, a second wheel secured to the first end of the second leg, and a third wheel secured to the hinge mechanism;
c) A first attachment receptacle secured proximate to the hinge mechanism, and a second attachment mechanism positioned using an arm suspended by the hinge mechanism, between the first leg and the second leg.

15. The base according to claim 14, further including a limiting mechanism positioned proximate to the hinge mechanism, said limiting mechanism establishing a maximum angle between the first leg and the second leg.

16. The base according to claim 15, wherein the limiting mechanism provides support for the arm mechanism.

17. The base according to claim 16, wherein the arm mechanism is moveable relative to the first and second leg.
